(19) United States
(12) Patent Application Publication
(10) Pub. No.: US 2026/0064554 A1
(43) Pub. Date: Mar. 5, 2026

(54) Actionable Recommendations by Generative Artificial Intelligence Based on Influential Project Metrics

(71) Applicant: Oracle International Corporation, Redwood Shores, CA (US)

(72) Inventors: Yogendra Swami, Hyderabad (IN); Pyay Aung San, San Francisco, CA (US); George M Cherian, Thiruvananthapuram (IN); Sai Teja Repalle, Hyderabad (IN); Prithi Bandla, Mountain View, CA (US); Forrest Elliott, Burien, WA (US); Alexander Nathan Lederman, Seattle, WA (US); Manikandan Sankaran, Denver, CO (US); Cynthia Mariela Munoz Jugo, Cincinnati, OH (US); Peter Weiss, Golden, CO (US)

(73) Assignee: Oracle International Corporation, Redwood Shores, CA (US)

(21) Appl. No.: 19/185,743

(22) Filed: Apr. 22, 2025

Related U.S. Application Data
(60) Provisional application No. 63/690,738, filed on Sep. 4, 2024.

(51) Int. Cl. G06F 11/34; G06F 9/451; G06F 9/50; G06F 9/54

(52) U.S. Cl. CPC G06F 11/3409; G06F 9/451; G06F 9/5038; G06F 9/54

(57) ABSTRACT

Techniques for generating actionable recommendations to improve program performance using generative AI are disclosed. A system invokes an application programming interface (API) service to obtain a set of program attributes. The program is made up of multiple projects that share a strategic objective. The system determines an overall performance classification for the program and a set of key program metrics that influence the overall performance classification. The system generates a prompt using the key program metrics. The system provides the prompt to a generative AI model to generate a program summary and a set of actionable recommendations to improve program performance by improving one or more of the key program metrics.

### BENEFIT CLAIMS; RELATED APPLICATIONS; INCORPORATION BY REFERENCE

This application claims the benefit of U.S. Provisional Patent Application 63/690,738, filed Sep. 4, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to applying artificial intelligence (AI) to generate project recommendations. In particular, the present disclosure relates to identifying key metrics associated with program states and presenting recommendations for projects in the program based on the key metrics.

### BACKGROUND

Enterprises manage various programs to achieve strategic objectives. Programs are implemented by executing a collection of projects that are directed to achieving the strategic objective. Program managers frequently find it challenging to quickly grasp the overall status of their programs and pinpoint which projects within the programs require immediate attention, especially when dealing with complex financial metrics. This process can be time-consuming and demanding, increasing the risk of errors and the likelihood of missing critical details that affect the success of the program.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIG. 2 illustrates an example set of operations for generating actionable recommendations for programs using generative AI in accordance with one or more embodiments;

FIG. 3 illustrates an example set of operations for training a machine learning model in accordance with one or more embodiments;

FIG. 4 illustrates an example embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PROGRAM MANAGEMENT ARCHITECTURE
3. GENERATIVE MODELS
4. USING AI TO GENERATE PROJECT RECOMMENDATIONS
5. TRAINING A MACHINE LEARNING MODEL
6. EXAMPLE EMBODIMENT
7. COMPUTER NETWORKS AND CLOUD NETWORKS
8. HARDWARE OVERVIEW
9. MISCELLANEOUS; EXTENSIONS

### 1. General Overview

One or more embodiments generate a prompt, for a generative artificial intelligence model to produce recommendations for a program, based on metrics that are determined to be influential. This novel approach utilizes a particular configuration for utilizing a generative artificial intelligence model to initiate program modifications that improve an overall performance of the program.

Initially, a system invokes an API call to obtain attributes associated with a program that includes a collection of projects. The attributes include a set of metrics and values associated with the metrics that represent one or more performance measures of the program. The system determines an overall performance of the program based on the one or more performance measures. The system determines a subset of the metrics and values based on the influence of the metrics on an overall performance of the program. For example, a system may input the metrics and the values corresponding to the metrics for the program to a machine learning model. Based on the input, the machine learning model predicts a subset of the metrics based on an influence of the current values for the subset of metrics on the overall performance of the program. The system generates a prompt for a generative AI model that is based on the subset of metrics selected based on their influence on the overall performance of the program. Based on the prompt, the generative AI model generates one or more recommendations for improving the overall performance of the program. The recommendations are directed to improve the overall performance of the program by specifically addressing the subset of metrics determined by the machine learning model.

One or more embodiments use generative AI to generate actionable recommendations for projects that make up a program in an enterprise. A system tracks program and project metrics to measure the performance of the program and the projects that make up the program. For example, different projects within a program may relate to different products in a product line, different rollouts of an application to different customers, or different stages of product development and/or manufacturing to bring a product to market. The system applies a machine learning model to program data that includes the program metrics to identify a set of key metrics. The key metrics are a subset of metrics that have the greatest relative influence on the overall performance of the program compared to other metrics. The system generates a prompt to a generative Artificial Intelligence (AI) model, such as a large language model (LLM), to generate a program summary and recommendations for a subset of projects. The prompt specifies rules for determining the projects to include in the subset. In particular, the prompt directs the generative AI model to include projects in the subset of projects based on the key metrics of the projects. For example, the prompt may direct the generative AI model to generate recommendations for three projects, from among a set of ten projects, that have key metrics values that exceed thresholds more than the other seven projects in the set of ten projects. The generative AI model generates a summary of the program, more detailed summaries of the projects, and recommendations for the subset of projects. The recommendations include proposed actions for improving key metrics.

One or more embodiments implement actionable recommendations using one or more AI agents. AI agents may be structured hierarchically, such that a supervisor agent oversees the execution of operations by worker agents. In addition, worker agents may be assigned to different types of tasks. For example, one worker agent may be assigned to extract insightful summaries from data describing key performance indicators. Another worker agent may ensure dissemination of AI-generated insights and recommendations across projects and stakeholder groups. Another agent may be assigned to monitor the execution of recommendations and generate or initiate further recommendations.

One or more embodiments establish a link between program metrics data and a generative AI model such that a change in program metrics data results in the automated updating of output generated by the generative AI model. Specifically, an input for computing a prompt generator is programmatically connected to the program metrics data. In an example, the program metrics data that is being input to the prompt generator is identified based on a data type. The data type is stored in association with the prompt generator or in association with a configuration for generating the prompt. In another example, the program metrics data that is being input to the prompt generator is identified by a file location or memory location. The file location or memory location is stored in association with the prompt generator or in association with a configuration for generating the prompt.

The system includes predefined prompt content and variable prompt content. The predefined prompt content includes structured instructions such as “generate one recommendation for three separate projects . . . ”. The variable prompt content includes the program metrics data linked in the prompt. As the stored program metrics data changes, the output generated by the generative AI model changes. For example, the generative AI model may generate recommendations for a first set of projects based on a first set of program data at a first time. The generative AI model may generate recommendations for a second set of projects based on the same set of predefined prompt content and a second set of program data linked to the prompt.

One or more embodiments described in this Specification and/or recited in the claims may not be included in this General Overview section.

### 2. Program Management Architecture

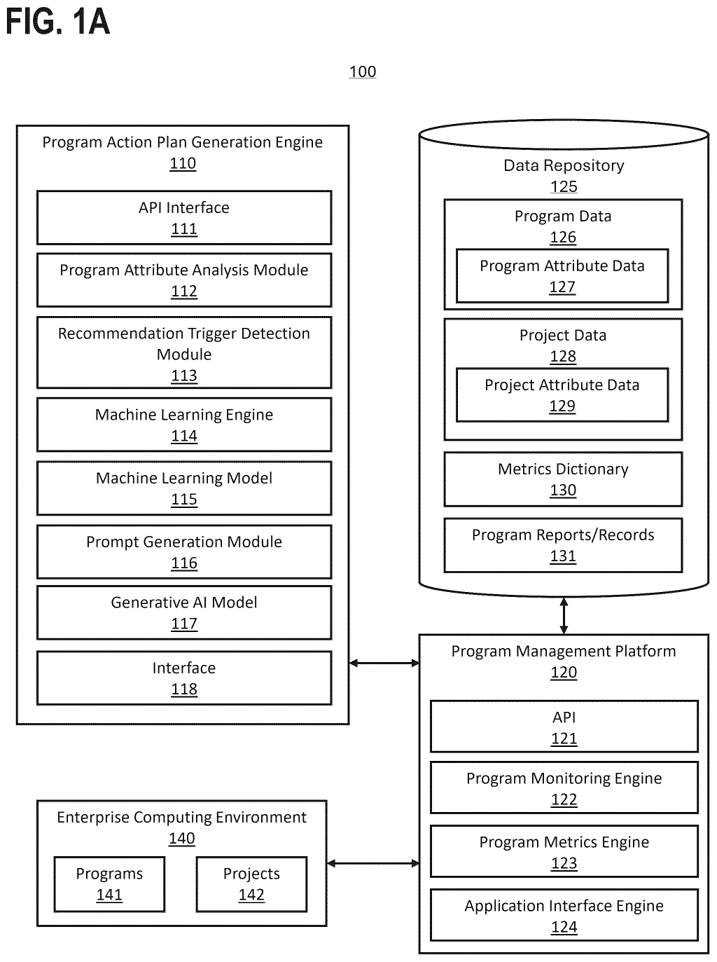

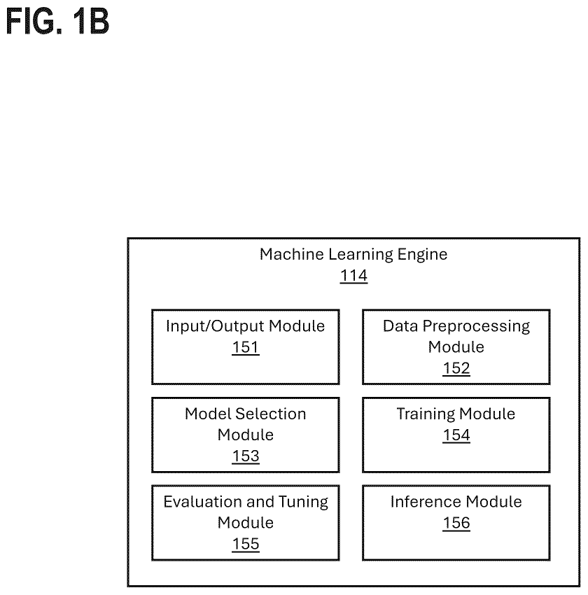

FIG. 1A illustrates a system 100 in accordance with one or more embodiments. As illustrated in FIG. 1A, system 100 includes a program action plan generation engine 110, a program management platform 120, a data repository 125, and an enterprise computing environment 140. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

A program management platform 120 manages programs 141 running in an enterprise computing environment 140. Programs 141 include one or more projects 142. In the present specification and claims, a project includes sets of tasks to be performed by an entity, resources for carrying out the tasks, and constraints applied to the tasks. A program 141 is a set of one or more projects.

According to one example, an enterprise may support a program to develop a cloud services product. The cloud services product includes multiple applications that customers may access on the cloud. The enterprise may classify the multiple applications as projects. Accordingly, the program of developing the cloud services product includes multiple projects for developing applications. The program and projects are characterized by a set of tasks. Tasks may include developing software to perform functions of the applications, obtaining hardware for running the applications in a cloud environment, obtaining access to hardware for communicating with clients over a network (such as by buying, leasing, renting, or building out data center resources), and securing customers for the cloud services product. The program and projects are characterized by resources. Resources include programmers, managers, computers for developing software, computer hardware for storing applications in a cloud network and providing access to the applications to customers, workers, manufacturing facilities, materials suppliers, product transport providers, and money. The project is associated with constraints, such as a budget, available hardware for programming and rolling out cloud services, available workers, such as programmers, technicians, project managers, and application support teams.

According to another example, an enterprise may support a program to develop a product line. The product line includes three products. The enterprise may classify the development of a product as a project. Accordingly, the program of developing the product line may include three projects. A project to develop a product is characterized by a set of tasks. Tasks may include designing a product, securing suppliers for materials, building out manufacturing capacity, employing workers, securing customers, and securing product transport. The project is characterized by resources. Resources include workers, manufacturing facilities, materials suppliers, product transport providers, and money. The project is associated with constraints, such as a budget, available hardware for manufacturing, available workers, and transport schedules.

The enterprise computing environment 140 includes suites of applications for supporting programs 141 and projects 142. Applications include financial applications for tracking and managing funds available, expenses, and budgets. Applications include project management applications for tracking and managing productivity records, such as outstanding tasks, tasks in progress, tasks completed, work metrics of workers, and availability of other resources, such as hardware resources for developing, producing, rolling out, and maintaining products.

Programs and projects are monitored by a program monitoring engine 122. The program monitoring engine 122 interfaces with the applications supporting the programs 141 and projects 142 to access and/or extract program and project attributes data from the applications. In some embodiments, applications store program data 126 and project data 128 in a data repository 125. Program data 126 includes program attributes data 127. Project data 128 includes project attribute data 129. Program data 126 and project data 128 include data used to support and run programs 141 and projects 142. Program data 126 and project data 128 include, for example, application code to run applications to track and manage programs and projects. Program attribute data 127 and project attribute data 129 include data describing the tasks, resources, and constraints associated with programs 141 and projects 142.

Examples of program and project attributes include resources, costs, constraints, tasks, and effects. Examples of program and project resources include financial and physical resources, such as money allocated to a project, income generated by a program, physical plants, warehouses, retail locations, office space, computing resources, physical product components, and manufacturing equipment. Examples of program and project costs include expenses to pay for product components, labor, and costs to purchase, rent, or lease work locations, data transmission capacity, and computing capacity. Examples of program constraints include budgets, geographic constraints, such as constraints on locations available for production or other work or constraints on available customers, constraints on a program or project size, and constraints on a size of a workforce. Examples of tasks include steps for manufacturing a product, steps for rolling out a software service, steps for upgrading an existing product available to customers, and steps for upgrading or modifying an existing system within an enterprise. Examples of effects include changes in cost, revenue, efficiency, production, computing capacity, applications available, workforce size, workforce composition, and organizational structure. While some examples of program and project attributes are described above, embodiments are not limited to the specified attributes.

A program metrics engine 123 obtains and generates program metrics based on the program and project attributes data 127 and 129. Some program metrics may quantify program and project attribute data 127 and 129. For example, a project attribute may be a cost incurred by a software development project. Example metrics may include total cost incurred or cost incurred in a specific timeframe such as in the previous fiscal year. Other metrics are calculated by applying a formula to one or more program or project attributes. For example, a metric may include a change in cost over time, a ratio of cost to personnel, and a net profit/loss as calculated based on a gross revenue and a gross cost for a specified time period.

Program metrics include both well-known or widely used metrics and custom program metrics. Types of program metrics include fundamental metrics, delivered metrics, and custom metrics. Fundamental metrics include pre-defined metrics for areas including budgets, forecasts, billing, costs, effort, margin, and capitalization. Delivered metrics are calculated based on the fundamental metrics. Custom metrics include any metrics defined by an entity that may not be fundamental or delivered metrics.

Examples of fundamental metrics include income, revenue, cost, cost variance, cost performance index, gross profit margin, return on investment, actual cost, schedule variance, schedule performance index, on-time delivery amount/percentage, earned value, productivity, efficiency, resource utilization, customer satisfaction, stakeholder satisfaction, and product quality measures.

Examples of metrics include Estimate at Completion (EAC) budget cost and Inception-to-Date (ITD) forecast revenue variance. EAC Budget Cost is an estimate of the total project cost at the end, calculated by adding the Actual Cost of Work Performed (ACWP) to date and the Estimate to Complete (ETC). EAC helps project managers monitor project costs, identify potential overruns, and make informed decisions about resource allocation and budgeting. Another metric may measure a difference between the planned budget, or Budget at Completion (BAC), for a project and the ETC. The ITD forecast revenue variance measures the difference between the current baseline budget revenue and the current approved forecast revenue. The ITD forecast revenue variance metric provides insight into how a project's revenue is deviating from the initial plan.

Additional examples of metrics include Effort variance and Prior Period Margin Percentage Variance. Effort variance measures the difference between the planned or budgeted effort required to complete a task or project and the actual effort expended. Effort variance may be calculated based on project attributes, including hours worked and resources expended. Prior Period Margin Percentage Variance Prior analyzes the change in a company's profit margin (e.g., gross margin, net margin) over time. It compares the current period's margin to the margin of the previous period.

The program management platform 120 maintains a metrics dictionary 130. The metrics dictionary describes the program and project attributes data 127 and 129 used to generate metrics.

The program management platform 120 includes an application interface engine 124. The application interface engine 124 interfaces with applications supporting the programs 141 and projects 142 to obtain the program attribute data 127 and the project attribute data 129. For example, the application interface engine 124 interfaces with financial applications to access and store revenue, cost, and budget data. The application interface engine 124 interfaces with project management applications to access and store resource utilization data and data describing hours worked by workers. In some embodiments, applications running in the enterprise computing environment 140 generate program reports and/or records 131. Program reports and records 131 may describe the progress of programs and projects. Program reports and records 131 may further describe program metrics for a given time period. For example, a project 142 may generate a weekly resource utilization report specifying the utilization of employees and computer systems available to the project. The application interface engine 124 interacts with one or both of the applications and the data repository 125 to access the attribute data stored in the program reports and/or records 131.

A program action plan generation engine 110 interfaces with an application programming interface (API) of the program management platform 120 to access program data 126 and project data 128 as well as to generate action plans to be implemented for programs and projects. In an embodiment, the program action plan generation engine 110 and the program management platform 120 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, a web server, a network policy server, a proxy server, and a mainframe.

An API interface 111 generates API requests to the API 121 of the program management platform 120. The API requests specify program data 126, including program attribute data 127, project data 128, including project attribute data 129, and metrics data, including metrics defined in the metrics dictionary 130. The API requests may further specify sets of program reports and records 131 that describe attributes and metrics for defined programs, projects, and periods of time.

A program attribute analysis module 112 analyzes the program attribute data 127 and the project attribute data 129 as well as metrics based on the attribute data 127 and 129. The program attribute analysis module 112 determines an overall performance of a program and/or a project based on the program attribute data 127 and the project attribute data 129. For example, based on costs, revenues, resource utilization, efficiency, and other attributes and metrics, the program attribute analysis module 112 may classify a program status as “On Track,” “At Risk,” “Overperforming,” or “Critical.” While a few examples of program status classifications describing an overall performance of programs and projects are provided, embodiments encompass any number of classifications. In addition, embodiments encompass varying types of classifications, including numerical classifications (e.g., 1-10), and color classifications.

In some embodiments, an interface 118 includes a graphical user interface (GUI) to present visual representations of program and project data. Visual representations may include textual descriptions, numerical representations, and graphics. Interface 118 refers to hardware and/or software configured to facilitate communications between a user and the program action plan generation engine 110. Interface 118 renders user interface elements and receives input via user interface elements. Examples of interfaces include a GUI, a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 118 are specified in different languages. The behavior of user interface elements is specified in a dynamic programming language such as JavaScript. The content of user interface elements is specified in a markup language, such as hypertext markup language (HTML) or XMLU ser Interface Language (XUL). The layout of user interface elements is specified in a style sheet language such as Cascading Style Sheets (CSS). Alternatively, interface 118 is specified in one or more other languages, such as Java, C, or C++.

A recommendation trigger detection module 113 monitors the program action plan generation engine 110 to determine if a recommendation trigger has been detected. For example, a recommendation trigger may include a user interaction with an interface element in the GUI. The interface element may be presented together with a set of program or project data. The interface element may include a label indicating selection of the interface element will provide an insight into the overall performance of the program or project. As another example, a recommendation trigger may include detecting a particular program status, overall performance classification, or change in performance or status of a project or program. The recommendation trigger detection module 113 may detect the classification of a project by the program attribute analysis module 112 as “At Risk.” The recommendation trigger detection module 113 may recognize the classification as a trigger.

Based on detecting the recommendation trigger, a machine learning engine 114 generates a dataset that includes one or both of program data 126 and project data 128. For example, if the program attribute analysis module 112 determines two projects in a program are “On Track” and one project is “At Risk”, the machine learning engine may generate a dataset that includes attributes and metrics for the “At Risk” project but omits attributes and metrics for the “On Track” projects.

FIG. 1B illustrates an example of a machine learning engine 114 according to one or more embodiments. As illustrated in FIG. 1B, machine learning engine 114 includes input/output module 151, data preprocessing module 152, model selection module 153, training module 154, evaluation and tuning module 155, and inference module 156.

In accordance with an embodiment, input/output module 151 serves as the primary interface for data entering and exiting the system by managing the flow and integrity of data. This module may accommodate a wide range of data sources and formats to facilitate integration and communication within the machine learning architecture.

In an embodiment, an input handler within input/output module 151 includes a data ingestion framework capable of interfacing with various data sources, such as databases, APIs, file systems, and real-time data streams. This framework is equipped with functionalities to handle different data formats (e.g., CSV, JSON, X machine learning) and efficiently manage large volumes of data. It includes mechanisms for batch and real-time data processing that enable the input/output module 151 to be versatile in different operational contexts, whether processing historical datasets or streaming data.

In accordance with an embodiment, input/output module 151 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 151 includes an output framework designed to handle the distribution and exportation of outputs, predictions, or insights. Using the output framework, input/output module 151 formats these outputs into user-friendly and accessible formats, such as reports, visualizations, or data files compatible with other systems. Input/output module 151 also ensures secure and efficient transmission of these outputs to end-users or other systems in an embodiment and may employ encryption and secure data transfer protocols to maintain data confidentiality.

In accordance with an embodiment, data preprocessing module 152 transforms data into a format suitable for use by other modules in machine learning engine 114. For example, data preprocessing module 152 may transform raw data into a normalized or standardized format suitable for training machine learning models and for processing new data inputs for inference. In an embodiment, data preprocessing module 152 acts as a bridge between the raw data sources and the analytical capabilities of machine learning engine 114.

In an embodiment, data preprocessing module 152 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through various methods, such as imputation or removal of incomplete records, depending on the nature and volume of the missing data. Data preprocessing module 152 may be configured to handle anomalies in different ways depending on context. Data preprocessing module 152 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 152 includes a feature encoding framework that ensures categorical variables are transformed into a format that can be easily interpreted by machine learning algorithms. Techniques, like one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 152 processes new data for inference, data preprocessing module 152 replicates the same preprocessing steps to ensure consistency with the training data format. This helps to avoid discrepancies between the training data format and the inference data format, thereby reducing the likelihood of inaccurate or invalid model predictions.

In an embodiment, model selection module 153 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 153 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 153 utilizes techniques from the field of Automated Machine Learning (Automachine learning). Automachine learning systems automate the process of model selection by rapidly prototyping and evaluating multiple models. They use different techniques, like Bayesian optimization, genetic algorithms, or reinforcement learning, to explore the model space efficiently. Model selection module 153 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 153 also considers computational efficiency and resource constraints. This is meant to help ensure the selected model is both accurate and practical in terms of computational and time requirements. In an embodiment, certain features of model selection module 153 are configurable such as a configured bias toward (or against) computational efficiency.

In accordance with an embodiment, training module 154 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 154 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 154 manages overfitting, where a model learns the training data too well, including its noise and outliers, at the expense of its ability to generalize to new data. Techniques, such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 154 includes logic to handle different types of data and learning tasks. For instance, it includes different training routines for supervised learning (where the training data comes with labels) and unsupervised learning (without labeled data). In the case of deep learning models, training module 154 also manages the complexities of training neural networks that include initializing network weights, choosing activation functions, and setting up neural network layers.

In an embodiment, evaluation and tuning module 155 incorporates dynamic feedback mechanisms and facilitates continuous model evolution to help ensure the system's relevance and accuracy as the data landscape changes. Evaluation and tuning module 155 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 155 performs continuous model tuning by using hyperparameter optimization. Evaluation and tuning module 155 performs an exploration of the hyperparameter space using algorithms, such as grid search, random search, or more sophisticated methods like Bayesian optimization. Evaluation and tuning module 155 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 155 integrates data feedback and updates the model. Evaluation and tuning module 155 actively collects feedback from the model's real-world applications, an indicator of the model's performance in practical scenarios. Such feedback can come from various sources depending on the nature of the application. For example, in a user-centric application, such as a recommendation system, feedback might comprise user interactions, preferences, and responses. In other contexts, like predicting events, it might involve analyzing the model's prediction errors, misclassifications, or other performance metrics in live environments.

In an embodiment, feedback integration logic within evaluation and tuning module 155 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 155 employs version control mechanisms to track changes, modifications, and the evolution of the model, facilitating transparency and allowing for rollback, if necessary. This continuous learning and adaptation cycle, driven by real-world data and feedback, helps to endure the model's ongoing effectiveness, relevance, and accuracy.

In an embodiment, inference module 156 transforms data raw data into actionable, precise, and contextually relevant predictions. In addition to processing and applying a trained model to new data, inference module 156 may also include post-processing logic that refines the raw outputs of the model into meaningful insights.

In an embodiment, inference module 156 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 156 transforms the outputs of a trained model into definitive classifications. Inference module 156 employs the underlying model as a tool to generate probabilistic outputs for each potential class. It then engages in an interpretative process to convert these probabilities into concrete class labels.

In an embodiment, when inference module 156 receives the probabilistic outputs from the model, it analyzes these probabilities to determine how they are distributed across some, or every, potential class. If the highest probability is not significantly greater than the others, inference module 156 may determine that there is ambiguity or interpret this as a lack of confidence displayed by the model.

In an embodiment, inference module 156 uses thresholding techniques for applications where making a definitive decision based on the highest probability might not suffice due to the critical nature of the decision. In such cases, inference module 156 assesses if the highest probability surpasses a certain confidence threshold that is predetermined based on the specific requirements of the application. If the probabilities do not meet this threshold, inference module 156 may flag the result as uncertain or defer the decision to a human expert. Inference module 156 dynamically adjusts the decision thresholds based on the sensitivity and specificity requirements of the application subject to calibration for balancing the trade-offs between false positives and false negatives.

In accordance with an embodiment, inference module 156 contextualizes the probability distribution against the backdrop of the specific application. This involves a comparative analysis, especially in instances where multiple classes have similar probability scores, to deduce the most plausible classification. In an embodiment, inference module 156 may incorporate additional decision-making rules or contextual information to guide this analysis, ensuring that the classification aligns with the practical and contextual nuances of the application.

In regression models, where the outputs are continuous values, inference module 156 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 156 incorporates domain-specific adjustments into its post-processing routine. This involves tailoring the model's output to align with specific industry knowledge or contextual information. For example, in financial forecasting, inference module 156 may adjust predictions based on current market trends, economic indicators, or recent significant events, ensuring that the outputs are both statistically accurate and practically relevant.

In an embodiment, inference module 156 includes logic to handle uncertainty and ambiguity in the model's predictions. In cases where inference module 156 outputs a measure of uncertainty, such as in Bayesian inference models, inference module 156 interprets these uncertainty measures by converting probabilistic distributions or confidence intervals into a format that can be easily understood and acted upon. This provides users with both a prediction and an insight into the confidence level of that prediction. In an embodiment, inference module 156 includes mechanisms for involving human oversight or integrating the instance into a feedback loop for subsequent analysis and model refinement.

In an embodiment, inference module 156 formats the final predictions for end-user consumption. Predictions are converted into visualizations, user-friendly reports, or interactive interfaces. In some systems, like recommendation engines, inference module 156 also integrates feedback mechanisms, where user responses to the predictions are used to continually refine and improve the model, creating a dynamic, self-improving system.

In an embodiment, input/output module 151 receives a dataset intended for training. This data can originate from diverse sources, like databases or real-time data streams, and in varied formats, such as CSV, JSON, or X machine learning. Input/output module 151 assesses and validates the data, ensuring its integrity by checking for consistency, data ranges, and types.

In an embodiment, training data is passed to data preprocessing module 152. Here, the data undergoes a series of transformations to standardize and clean it, making it suitable for training machine learning models. This involves normalizing numerical data, encoding categorical variables, and handling missing values through techniques like imputation.

In an embodiment, prepared data from the data preprocessing module 152 is then fed into model selection module 153. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 154 trains the selected model with the prepared dataset. It implements learning algorithms to adjust the model's internal parameters, optimizing them to identify patterns and relationships in the training data. Training module 154 also addresses the challenge of overfitting by implementing techniques, like regularization and early stopping, ensuring the model's generalizability.

According to an example embodiment, machine learning model 115 includes a neural network. For example, machine learning model 115 may be implemented as deep-learning neural networks. The training module 154 applies a machine learning algorithm to a training data set to the machine learning model 115. For example, the machine learning algorithm may analyze the training data set to train neurons of a neural network with particular weights and offsets to associate particular electronic document feature sets with particular document classifications or classes.

In some embodiments, the training module 154 iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the training module 154 may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one feature may depend on its position within a sequence of feature vector representations. Thus, the nodes may have a memory to remember relevant temporal dependencies between different sets of input features.

In some embodiments, the training module 154 compares the labels estimated through the one or more iterations of the machine learning model algorithm with observed labels to determine an estimation error. The training module 154 may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the training module 154 determines whether or not to adjust the weights and/or other model parameters based on the estimation error. Adjustments may be made until a candidate model that minimizes the estimation error or otherwise achieves a threshold level of estimation error is identified. In some embodiments, the training module 154 selects machine learning model parameters based on the estimation error meeting a threshold accuracy level. For example, the system may select a set of parameter values for a machine learning model based on determining that the trained model has an accuracy level for predicting labels of at least 98%.

In an embodiment, evaluation and tuning module 155 evaluates the trained model's performance using the validation dataset. Evaluation and tuning module 155 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 151 receives a dataset intended for inference. Input/output module 151 assesses and validates the data.

In an embodiment, data preprocessing module 152 receives the validated dataset intended for inference. Data preprocessing module 152 ensures that the data format used in training is replicated for the new inference data, maintaining consistency and accuracy for the model's predictions.

In an embodiment, inference module 156 processes the new data set intended for inference, using the trained and tuned model. It applies the model to this data, generating raw probabilistic outputs for predictions. Inference module 156 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In one or more embodiments, the training module 154 applies a machine learning algorithm to train the machine learning model 115. The machine learning algorithm is an algorithm that can be iterated to train a target model f that best maps a set of input variables to an output variable. One example machine learning algorithm is an algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model fand accuracy of the current target model f. Updated training data is fed back into the machine learning algorithm, which in turn updates the target model f.

The example machine learning algorithm generates a target model f such that the target model f best fits the datasets of training data to the labels of the training data. Additionally, or alternatively, the example machine learning algorithm generates a target model f such that when the target model f is applied to the datasets of the training data, a maximum number of results determined by the target model f matches the labels of the training data. Different target models be generated based on different machine learning algorithms and/or different sets of training data.

The example machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The machine learning model 115 predicts a subset of attributes or metrics based on an influence of the attributes or metrics with the overall performance of a program or project. For example, if a set of program metrics includes 160 metrics, the output of the machine learning model may be three metrics. The three metrics are those that the machine learning model 115 predicts have a greater influence on the overall performance of the program than the remaining 157 metrics. As another example, the machine learning model may generate 160 ranking values corresponding to the 160 metrics. A higher ranking value may correspond to a prediction of a greater influence on an overall performance of the program. For example, the top three ranking values may correspond to three metrics that the machine learning model predicts have a greater influence on the overall performance of the program than the remaining 157 metrics.

The machine learning model 115 is trained to identify relationships between metrics values and overall performance categories. For example, a program may have an overall performance category of “at risk.” The program may be characterized by positive metrics associated with being on budget as well as 100 additional metrics. The program may be characterized by negative metrics associated with on-time delivery, resource utilization, and return-on-investment as well as 57 additional metrics. The machine learning model 115 predicts, based on the relationships among metrics and overall performance learned during training, that the on-time delivery is the primary metric influencing the classification of the program as “at risk.” Based on a different set of input values for the same set of metrics, the machine learning model may predict that expenses exceeding a budgeted amount is the primary metric influencing the classification of the program as “at risk.” According to another example, the machine learning model 115 may identify a metric that has a positive value as being a primary contributor to an “at risk” overall performance classification. The machine learning model may determine that although a value for the metric is positive, the trend for the metric is decreasing over time. The machine learning model may determine that the trend for the metric, rather than its present value, results in the metric being a primary contributor to an overall performance category for a program.

In an embodiment, the program attribute analysis module 112 applies a set of rules to generate a classification of a program or project based on an overall performance of the program or project. For example, a rule may specify that if a number of metrics with values that fail to meet a threshold value exceeds a threshold number of metrics, the overall performance of a program is “at risk.” If the number fails to meet a second threshold, the overall performance may be classified as “critical.” The set of rules may apply different weights to different metrics. Accordingly, the system may classify a program as being “at risk” when 5 metrics classified as “high importance” fail to meet a performance threshold. The system may classify the program as being “on track” when 8 metrics classified as “low importance” fail to meet performance thresholds. The system may classify the program as being “at risk” when 10 or more metrics classified as “low importance” fail to meet performance thresholds.

In an alternative embodiment, the system trains a machine learning model to generate an overall performance prediction for a program or project. The machine learning model for generating the overall performance prediction may be separate from the machine learning model 115 for predicting a subset of program metrics. The system may apply the set of project metrics and attributes to one model to predict an overall program performance classification. The system may apply the classification and the set of project metrics and attributes to another model trained to predict the subset of attributes and program metrics that have a higher influence on the overall performance classification than other attributes and metrics.

A prompt generation module 116 obtains the subset of program metrics predicted by the machine learning model 115 and a set of instructions for generating a prompt. The set of instructions may specify attributes of generative AI content, including a type of text to be generated, a length of text to be generated, and any visual elements to be generated. For example, a prompt may include a set of instructions to “generate a narrative not exceeding 4 sentences to explain the program overall performance,” “select a set of up to 5 projects in the program for generating recommendations,” and “generate a set of actionable recommendations for the selected projects.”

In embodiments, prompt generation module 116 generates a prompt that includes instructions to generate a program summary and recommendations for improving performance of a subset of projects included in the program. The prompt specifies rules for determining a subset of projects to include in the subset. In particular, the prompt directs the generative AI model to include projects in the subset of projects based on the key metrics of the projects. For example, the prompt may direct the generative AI model to generate recommendations for three projects, from among a set of ten projects, that have key metrics values that exceed thresholds more than the other seven projects in the set of ten projects.

The generative AI model 117 generates narrative and/or visual content to describe the overall performance of the program and to provide actionable recommendations based on the prompt. In particular, the generative AI model 117 incorporates the subset of program metrics predicted by the machine learning model 115 as influencing the overall performance classification of the program into its content. The generative AI model 117 may generate actionable recommendations based on improving performance of the subset of program metrics to improve the overall performance of the program. In one example, the generative AI model 117 generates a summary of a program, more detailed summaries of the subset of projects, and recommendations for the subset of projects. The recommendations include proposed actions for improving key metrics.

In one or more embodiments, a prompt generation module 116 establishes a link between program data 126 and the generative AI model 117. The program attribute analysis module 112 may regularly monitor program data 126 and project data 128 associated with prompts generated by the prompt generation module 116 and recommendations generated by the generative AI model 117. When the program attribute analysis module 112 detects a change in program metrics data used by the generative AI model 117 to generate recommended actions, program attribute analysis module 112 determines if the changes correspond to a change in the overall performance of the corresponding program. If an overall performance classification change is detected, the machine learning model 115 may generate a new prediction to identify a new subset of program metrics, the prompt generation module 116 may generate a new prompt, and the generative AI model 117 may generate a new set of content with new recommendations based on the changes to the program metrics data.

Additional embodiments and/or examples relating to computer networks are described below in Section 7, titled “Computer Networks and Cloud Networks.”

In one or more embodiments, a data repository 125 is any type of storage unit and/or device (e.g., a file system, database, collection of tables, or any other storage mechanism) for storing data. Furthermore, a data repository 125 may include multiple different storage units and/or devices. The multiple different storage units and/or devices may or may not be of the same type or located at the same physical site. Furthermore, a data repository 125 may be implemented or executed on the same computing system as the program management platform 120. Additionally, or alternatively, a data repository 125 may be implemented or executed on a computing system separate from the program management platform 120. The data repository 125 may be communicatively coupled to the program management platform 120 via a direct connection or via a network.

Information describing program data 126, project data 128, a metrics dictionary 130, and program reports and records 131 may be implemented across any of components within the system 100. However, this information is illustrated within the data repository 125 for purposes of clarity and explanation.

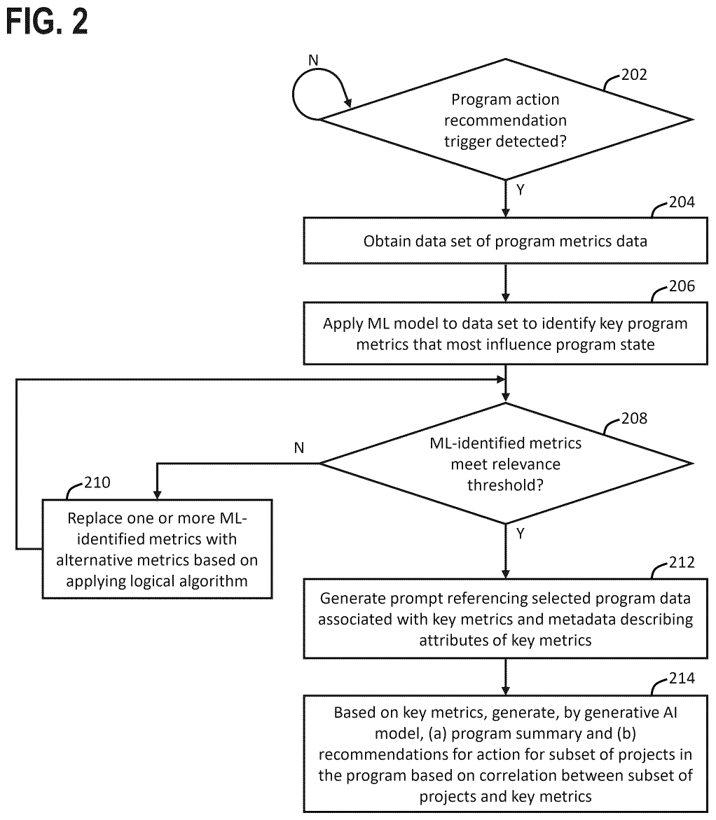

In one or more embodiments, program action plan generation engine 110 refers to hardware and/or software configured to perform operations described herein for generating actionable recommendations to improve program performance based on identifying key program metrics associated with overall program performance. Examples of operations for improving program performance based on identifying key program metrics associated with overall program performance are described below with reference to FIG. 2.

### 3. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

One type of generative model is a large language model (LLM). Large language models (LLMs) are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 151, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text after generating predictions or responses.

In accordance with one or more embodiments, data preprocessing module 152 in the context of LLMs may include a step, like normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 153, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 154, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 155 assesses the performance of LLMs using various metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 156, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, large multimodal models (LMMs) learn to create coherent and contextually relevant outputs across various modalities, enhancing their utility in complex, real-world scenarios.

The architecture of LMMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLM s and LMMs belong to the broad category of generative models. For example, stochastic models directly incorporate randomness into their structure, making them inherently generative as they can produce a diverse set of outputs for a given input. Using a dual-network architecture that involves a generative component, Generative Adversarial Networks (GANs) learn to generate new data that is indistinguishable from the data they were trained on. Variational Autoencoders (VAEs) are explicitly designed for generating new data points by learning a distribution of the input data and encoding inputs into a latent space and generating outputs by sampling from this space, making them inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 4. Using AI to Generate Project Recommendations

FIG. 2 illustrates an example set of operations for generating actionable recommendations for a program using artificial intelligence (AI) in accordance with one or more embodiments. One or more operations illustrated in FIG. 2 may be modified, rearranged, or omitted. Accordingly, the sequence of operations illustrated in FIG. 1 should not be construed as limiting the scope of one or more embodiments.

In an embodiment, the system detects a trigger for program action recommendations (Operation 202). The trigger may include a user selecting an interface element of a GUI. The interface element may present text to “generate program insights” or “generate program recommendations.” The interface element may be coded to initiate a sequence of operations to generate a program summary and project insights.

In one or more embodiments, a program is a collection of projects that share a common strategic objective. For example, a program may include managing a product line. One project may be to develop a new product in the product line. The project may involve one or more teams that conduct research, develop specifications for the new product, and develop a prototype or working example of the product. Another project may include customer acquisition for an existing product. Tasks in a customer acquisition product may include managing a database of potential customers, conducting pitches to potential customers, and running an advertising campaign. Another project may include upgrading an existing product. Tasks in a project to upgrade an existing product may include identifying specifications for the upgrade, testing, and rollout. Examples of types of programs include programs to create, develop, maintain, and upgrade goods and devices, services, and software applications such financial applications.

In addition to user input, the system may detect additional types of triggers, including detecting program metrics that meet a recommendation threshold. For example, a system may monitor the status of a set of projects in a program. The system may be configured with thresholds for performance metrics, such as total revenue, change in revenue year-over-year, profit, and costs to maintain a project. A trigger may include determining that one or more metrics (such as total revenue) for any project fall below a threshold, that one or more metrics exceed a threshold, or that a set of metrics for a threshold number of projects in the program fall below or exceed a performance threshold.

Based on detecting the recommendations trigger, the system obtains a set of program metrics data (Operation 204). The system identifies the program associated with the trigger and the location of metrics data associated with the program. For example, the system may identify metric log files, reports, and tables associated with a program and the projects that make up the program. For example, a program may include three projects: ABC Co. Application Upgrade, DEF Co. Application Implementation, and GHI Co. Application Implementation. For each project, the system may store metrics data including the following: budget, expenses, income, revenue, margin, invoices sent, and/or payments received.

In one or more embodiments, program and project metrics include any measurable data related to the performance of the program and project. In addition to financial metrics, other metrics include metrics related to a supply chain, such as inventory and deliveries. Other metrics may measure employee and team performance, including salary, number of employees, efficiency, deadlines met, and deadlines missed. Other metrics may measure customer performance, including customer size (e.g., number of employees at a customer company), revenue generated from customer orders, quantity of purchases, invoices paid, invoices unpaid, invoices paid late, etc.

In one or more embodiments, the system obtains the data set of program metrics by invoking a Representational State Transfer (REST) call to an API of a program management server. A client device constructs a Hypertext Transfer Protocol (HTTP) request. The HTTP request specifies the retrieval of program attributes and/or program metrics data. For example, the request may specify a GET operation to obtain the attributes and/or metrics data. The request may include the Uniform Resource Locator (URL) of the requested data. A server receives and processes the HTTP request according to a REST API endpoint associated with the request. The server performs authentication, authorization, and validation checks to ensure the client has the necessary permissions to access the requested program attributes and metrics data. The server retrieves the requested data from a data repository such as a database.

Once the server has processed the request, it constructs an HTTP response. The response includes an HTTP status code to indicate the outcome of the request. The response body may contain the requested data. The requested data may be presented in a format ingestible by the client such as JSON format. The server transmits the response to the client. The client receives the response and processes the data. While FIG. 2 illustrates the system obtaining program metrics data subsequent to detecting a trigger, in some embodiments, the system first invokes the REST call to an API to obtain the program metrics. The system may analyze the program metrics to detect the trigger.

In one embodiment, a program may include multiple projects. The client may generate one request for aggregated program data and a number of separate requests associated with separate projects. For example, a program management platform may store program data and metrics that describe a performance of a program. The platform may store project data and metrics that describe the performance of individual projects that make up the program. In some embodiments, the client learns an organizational structure of the program from the results of initial request for program data. Based on the learned organizational structure, the client may iteratively generate additional requests directed to sub-parts of the program such as the separate projects that make up the program.

The system applies a machine learning model to a data set to identify key program metrics (Operation 206). The machine learning model may predict the key program metrics have a greater influence on an overall performance classification of the program than other, non-selected program metrics. The machine learning model may be trained on a training data set comprising program and project metrics and a program and project overall performance. For example, a training data point may include a set of program metric values and a label indicating the program is underperforming overall, is costing more than budgeted, and is taking in less revenue than predicted. Another training data point may include another set of program metric values, a label indicating the program is performing to expectations, a set of project metrics identifying a first project as bringing in less revenue than expected, and a second project as bringing in more revenue than expected.

The system iteratively applies the machine learning algorithm to the training data set to identify data and patterns that indicate relationships between particular metrics and particular program and project overall performance classifications. Types of machine learning models include, but are not limited to, linear regression, logistic regression, linear discriminant analysis, classification and regression trees, naïve Bayes, k-nearest neighbors, learning vector quantization, support vector machine, bagging and random forest, boosting, backpropagation, and/or clustering.

In one embodiment, the machine learning model is trained to generate feature importance values. The feature importance values indicate a subset of metrics, from among the set of metrics fed to the model as input data, that have a relatively greater influence on the model's prediction of the program's overall performance compared to other program metrics. In a linear model, a system may calculate feature importance to identify key metrics by using linear regression/logistic regression and/or Ridge/Lasso regression. In linear and logistic regression, the coefficients of the features in the neurons of the model indicate their importance. A higher absolute value of a neuron corresponding to a feature represents a greater importance. In a Lasso-type regression, the system may determine a metric's importance based on how close the coefficient for the corresponding feature is to zero.

As another example, tree-based methods, such as random-forest type methods, may be applied to determine the importance of features and corresponding metrics to the model's predictions. For example, the system may apply a Gini Importance/Mean Decrease in Impurity (MDI) algorithm to measure the total decrease in node impurity brought by a feature across all trees. Alternatively, the system may apply a Mean Decrease Accuracy (MDA)/Permutation Importance algorithm to randomly permute a feature's values and observe the drop in model accuracy. The greater the drop, the more important the feature. According to yet another example, the system may apply a Shapley Additive Explanations (SHAP) model to generate a unified measure of feature importance, based on game theory.

As another example, the system may apply a permutation importance algorithm to identify the features and corresponding metrics that have the most influence on the model's prediction. The permutation importance algorithm is a model-agnostic algorithm that shuffles a feature's values and calculates the change in the model's performance. A larger decrease in performance indicates greater importance. As another example in which the machine learning model is a deep learning model, the system may apply integrated gradients of the model output with respect to input features.

In one embodiment, applying the machine learning model to the data set includes providing the dataset to a first machine learning model to predict an overall performance of a program and applying the dataset and the overall performance classification to a second machine learning model to predict a subset of program metrics having a relatively greater influence on the overall performance classification than other program metrics that are not among the subset of program metrics. In at least one embodiment, a system obtains embeddings from a hidden layer of the first model and provides the embeddings to the second model to predict the subset of program metrics.

The system determines if the machine-learning identified metrics meet a relevance threshold (Operation 208). For example, the system may identify three key metrics associated with the program status. However, the system may determine that a relevance of the key metrics to the program status does not meet a relevance threshold. The relevance threshold may measure the level of influence the key metrics have on the program status. As an example, the machine learning model may identify revenue, overdue invoices, and personnel shortages as being the three metrics that have the greatest influence of the program's “underperforming” status. However, the system may determine that the overdue invoices and personnel shortages have little impact on the program status; therefore, they do not meet the relevance threshold.

If the system determines the machine learning-identified metrics do not meet a relevance threshold, the system replaces one or more metrics with alternative metrics based on applying a logical algorithm (Operation 210). In the example above, in which the system identifies overdue invoices and personnel shortages as failing to meet the relevance threshold, the system replaces these metrics with alternative metrics based on a logical algorithm. For example, the system may maintain a set of rules specifying alternative metrics. The rules may include a list of metrics and priority levels associated with the metrics. If one or more machine learning identified metrics fail to meet the relevance threshold, the system may replace them with the highest-priority metrics on the list of metrics. The rules may specify different metrics for different program types. For example, a program implemented by one department in an enterprise may correspond to a different prioritization of metrics than another program implemented by another department in the same enterprise.

While an embodiment is described above where a system applies a machine learning model to identify a set of key metrics (Operations 206-210), in some embodiments, the system identifies the key metrics without reliance on the machine learning model. For example, a system may identify a set of key metrics associated with a particular program or project. Key metrics may be specified by a user, such as a program manager. Key metrics may be identified by analyzing written content associated with a program. For example, the system may analyze communications generated by a project manager to identify metrics referred to in the communications. If the system determines a project manager asks employees about productivity data, the system may identify productivity as a key metric for the project. Additionally, or alternatively, the system may analyze data associated with a project or program to identify key metrics associated with the types of data associated with the project or program. For example, the system may determine that one project generates financial data. The system may identify a set of financial key metrics to associate with the project. The system may determine that another project generates product development data. The system may identify a set of key metrics, such as budget metrics, expense metrics, and productivity metrics, associated with product development.

If the system determines the machine learning-identified metrics meet the relevance threshold, the system generates generative AI prompt referencing the selected program data associated with the key metrics (Operation 212). The generative AI prompt directs the generative AI model to generate a summary of the program. The summary of the program describes the program's status at a high level. For example, the summary may explain that the program is increasing or decreasing in revenue year-over-year. The summary may describe some projects as meeting deliverable goals and one or more projects as failing to meet deliverable goals. In one or more embodiments, the generative AI prompt includes an instruction to generate one or more graphs to depict the content described in the project summary. The generative AI prompt directs the generative AI model to generate separate descriptions for separate projects that make up the program. The generative AI prompt directs the generative AI model to describe the projects in terms of a set of metrics that includes the key metrics. As an example, a system may track 100 or more metrics. The generative AI prompt may include instructions to generate a description including (a) values for the key metrics and (b) values for a set of additional metrics of note such as a metric where the project is performing above predictions or below predictions.

The generative AI prompt further references metadata describing attributes of the key metrics. For example, if the machine learning model and/or logic identify three metrics as the key metrics, the system identifies where data associated with the key metrics is stored. If the key metrics include a revenue metric, the system may provide an address to a storage location that stores a table of revenue over time for a set of projects that make up the program. If the key metrics include an invoices unpaid metric, the system may provide, in the generative AI prompt, an address to a set of data describing the paid/unpaid status of invoices. As another example, if the key metrics include an unsold inventory metric, the system may provide an address to the generative AI model of data representing inventory at one or more sales locations over time. In one embodiment, the data may be stored as tables in a database. The generative AI prompt may include query language to initiate a query to the database. As another example, the data may be stored as tables in a file system. The generative AI prompt may include an address of the files stored in the file system. According to yet another example, data may be stored in a webpage. The generative AI prompt may include a URL to the webpage.

The generative AI prompt includes an instruction for the generative AI model to generate recommendations for a subset of projects that make up the program. The instruction may direct the generative AI model to generate several recommendations for a specified number of projects that have key metric values that most exceed/fall below thresholds. For example, the generative AI prompt may direct the generative AI model to identify the three projects for which revenue in the previous quarter (a) fell compared to the previous quarter and (b) fell by the highest percentage compared to the same quarter in the previous year. The generative AI prompt may direct the generative AI model to generate between one to three recommendations for increasing revenue for the three projects.

One or more embodiments provide attribute data to the generative AI model describing metrics. The machine learning model identifies key metrics without requiring any underlying understanding of what the metrics represent, such as financial data, product data, employee data, system operation data, or customer data. However, the generative AI model requires the meaning of the metrics to generate a natural language explanation of the status of the program, projects, and recommendations for the projects. Accordingly, the system provides the generative AI model, in the prompt, with a dictionary of metrics and a natural language explanation of what the metric measures. The dictionary may be stored as metadata that describes the metrics data. Accordingly, the generative AI model may generate summaries and recommendations for different entities that use different terms for a particular feature or that use the same term for different features.

One or more embodiments establish a link between program metrics data and a generative AI model such that a change in program metrics data results in the automated updating of output generated by the generative AI model. Specifically, an input for computing a generative AI prompt generator is programmatically connected to the program metrics data. In an example, the program metrics data that is being input to the generative AI prompt generator is identified based on a data type. The data type is stored in association with the generative AI prompt generator or in association with a configuration for generating the prompt. In another example, the program metrics data that is being input to the generative AI model prompt generator is identified by a file location or memory location. The file location or memory location is stored in association with the generative AI model prompt generator or in association with a configuration for generating the prompt.

For example, a system may store a set of tables that store values for metrics and projects in a program. The system stores a link to the tables in a software program for generating the generative AI prompt to instruct the generative AI model to generate recommended actions for a subset of projects. The system further stores links to digital files storing project information for a set of projects that includes the subset of projects. When the system identifies a subset of key metrics, the system generates generative AI prompt instructions to (a) identify the key metrics in the table pointed to in the software program and (b) select the subset of projects for generating recommendations based on the key metrics values of the projects. Based on selecting the subset of projects, the generative AI model refers to the links to the digital files storing project information for the set of projects to generate project descriptions and recommendations. The system updates key metrics data stored in the key metrics table over time. Accordingly, the subset of projects selected in one time period may differ from a subset of projects selected in a subsequent time period. In addition, the system updates the project information in the digital files over time. Accordingly, the project description and recommendations generated in one time period may differ from the description and recommendations generated in another time period.

Based on the prompt referencing the selected program data and metadata, the generative AI model generates a program summary, identifies a set of projects in the program that are most relevant to the key metrics, and generates recommendations for actions to take in the projects to improve program performance (Operation 214). The project summary includes a natural language description of the program. The description may include an indicator of the status of the program, such as if the program is performing as expected, better than predicted, or worse than predicted. The description may reference the key metrics across the set of projects that make up the program. For example, the description may describe the program as meeting revenue targets but falling in revenue compared to the previous quarter and dealing with increased costs. The description of the set of projects may reference key metrics. Continuing with the example in which the key metrics include revenue, costs, and margins, the project description may include a description of the revenue, costs, and margins for the project. The recommendations include natural language description of remedial actions to be taken for respective projects. For example, one recommendation may be to “monitor this project's costs closely . . . ”. Another recommendation may be to “correct entries in table of received invoices . . . ”. Y et another recommendation may be to “consider feasibility study to predict this project's performance over the next year . . . ”.

While FIG. 2 illustrates an example where a machine learning model identifies key metrics, one or more embodiments apply logical rules to identify key metrics and a corresponding a subset of projects. For example, the logical rules may specify a subset of metrics that measure project performance. The system may apply the logical rules to identify a subset of projects that make up a program that have values for the subset of metrics that exceed or fall below thresholds by the greatest margins. For example, the logic may identify key metrics, such as revenue, costs, and margins. The system may apply the logic to the project data for the projects that make up the program to identify a subset of projects that have values for the key metrics that exceed or fall below thresholds by the greatest margins. When determining if projects have values for key metrics that exceed or fall below thresholds by the greatest margins, the system may apply weights to particular key metrics to identify the subset of projects. Alternatively, the system may combine values representing the differences between the key metrics and the thresholds to generate a compound value representing the key metrics. The system may identify the subset of projects based on the projects having the highest compound values.

### 5. Training a Machine Learning Model

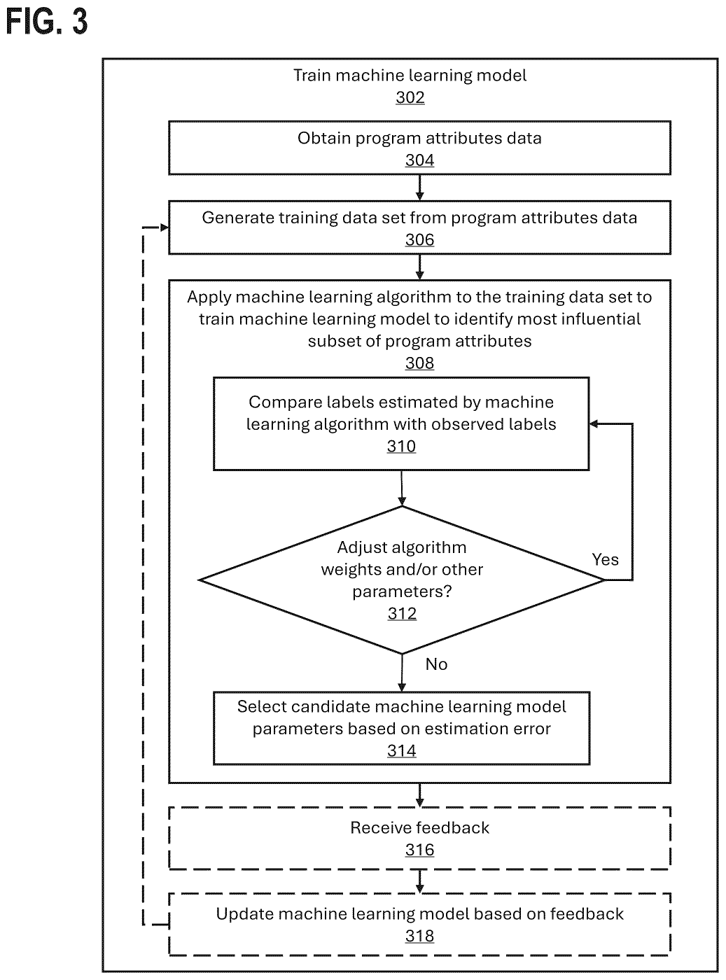

FIG. 3 illustrates an example set of operations for training a machine learning model (Operation 302) to predict a subset of program metrics in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In some embodiments, a system (e.g., one or more components of system 100 illustrated in FIG. 1A) obtains program attributes data (Operation 304). Obtaining the program attributes data may include obtaining program attributes and project attributes for projects within the program. The program and project attributes include program metrics that represent performance measures of the program and projects.

The system uses the program attributes data to generate a set of training data (Operation 306). The set of training data includes, for a particular set of program metrics values, at least one classification label representing an overall performance of the program. For example, the system may identify one combination of values among 100 program metrics values as corresponding to an overall performance of “on track.” The system may identify another combination of values among the 100 program metrics as “warning.” Other combinations of program metric values may correspond to performance classifications of “exceeding expectations” or “critical.”

In some embodiments, generating the training data set includes generating a set of feature vectors for the labeled examples. A feature vector for an example may be n-dimensional, where n represents the number of features in the vector. The number of features that are selected may vary depending on the particular implementation. In some embodiments, the number of features corresponds to a number of program metrics, and the number exceeds 100. The features may be curated in a supervised approach or automatically selected from extracted attributes during model training and/or tuning. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 308). For example, the machine learning algorithm may analyze the training data set to train neurons of a neural network with particular weights and offsets to associate particular sets of program metric values with particular (a) overall program performance classification labels, (b) rankings of program metrics based on influence of the program metrics on an overall program performance classification, and/or (c) selection of subsets of program metrics based on influence of the program metrics on an overall program performance classification.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the system may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one performance metric value may depend on its position within a sequence of feature vector representations for the performance metric. Thus, the nodes may have a memory to remember relevant temporal dependencies between values for a performance metric over time. For example, a performance metric in isolation may have a first set of weights applied by nodes as a function of the respective feature vector for the performance metric. However, the set of weights may differ depending on the value of the performance metric immediately preceding the current performance metric value. Additionally, or alternatively, the system may generate and train other candidate models, such as support vector machines, decision trees, Bayes classifiers, and/or fuzzy logic models, as previously described.

In some embodiments, the system compares the labels estimated through the one or more iterations of the machine learning model algorithm with observed labels to determine an estimation error (Operation 310). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether or not to adjust the weights and/or other model parameters based on the estimation error (Operation 312). Adjustments may be made until a candidate model that minimizes the estimation error or otherwise achieves a threshold level of estimation error is identified. The process may return to Operation 310 to make adjustments and continue training the machine learning model.

In some embodiments, the system selects machine learning model parameters based on the estimation error meeting a threshold accuracy level (Operation 314). For example, the system may select a set of parameter values for a machine learning model based on determining that the trained model has an accuracy level for predicting subsets of program metrics of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of program metric values. Each program metric value may be processed as a separate discrete instance of time. For instance, an example may include program metric values c1, c2, and c3, corresponding to times t, t+1, and t+2, respectively. Backpropagation through time may perform adjustments through gradient descent starting at time t+2 and moving backward in time to t+1 and then to t. Furthermore, the backpropagation process may adjust the memory parameters of a cell such that a cell remembers contributions from previous program metric values in the sequence of program metric values. For example, a cell computing a contribution for e3 may have a memory of the contribution of e2, which has a memory of e1. The memory may serve as a feedback connection such that the output of a cell at one time (e.g., t) is used as an input to the next time in the sequence (e.g., t+1). The gradient descent techniques may account for these feedback connections such that the contribution of one program metric value to a cell's output may affect the contribution of the next program metric value in the cell's output. Thus, the contribution of c1 may affect the contribution of c2, etc.

Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of expenses.

In embodiments in which the machine learning algorithm is a supervised machine learning algorithm, the system may optionally obtain feedback on the various aspects of the analysis described above (Operation 316). For example, the feedback may affirm or revise labels generated by the machine learning model. The machine learning model may indicate that a particular set of program metric values and overall program performance classification are associated with a label “monitor closely.” The system may receive feedback indicating that the particular set of program metric values and overall program performance classification should instead be associated with a label “on track.” Based on the feedback, the machine learning training set may be updated, thereby improving its analytical accuracy (Operation 318). Once updated, the system may further train the machine learning model by optionally applying the model to additional training data sets.

### 6. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

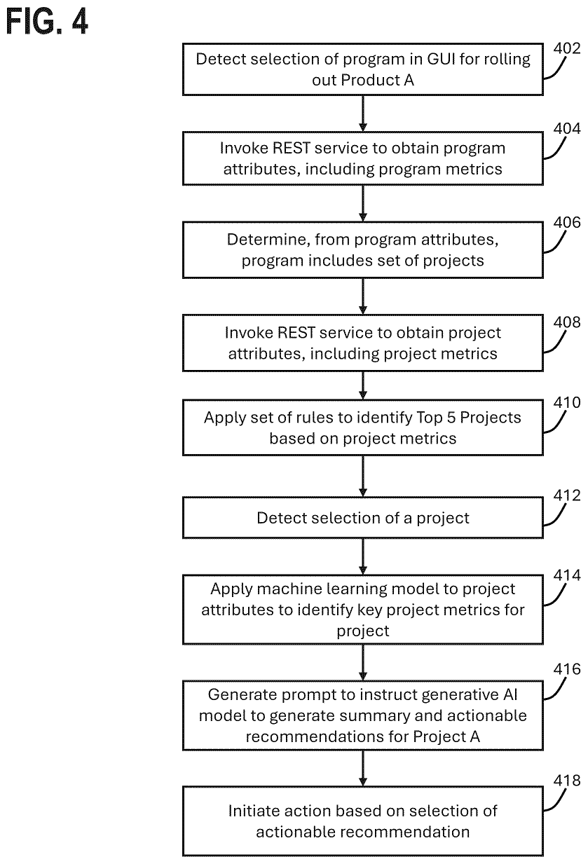

FIG. 4 illustrates example set of operations for generating recommendations for applying to programs and projects using a generative AI model.

A system presents a GUI that includes a set of programs. The system detects a user selection of a program entitled “North America Application Implementations,” referring to an application being provided to consumers in North America (Operation 402). In an embodiment, the system detects the selection of the program based on a user's interaction with an interface element in the GUI identifying the program.

The system invokes a REST service to obtain program attributes, including program metrics, for the program “North America Application Implementations” (Operation 404). Program attributes include revenues, expenses, estimated time to complete, estimated costs and revenues, budgeted costs and revenues, and resources available. Program metrics include an ITD margin variance program metric, an ITD revenue variance metric, and an ITD cost variance metric.

The system determines the program includes ten projects that correspond to ten different implementations of the application in North America (Operation 406). The program attributes may include organizational data for the program, including projects that are included in the program.

Based on determining the program includes multiple projects, the system invokes a REST service to obtain project attributes, including project metrics for the ten projects included in the program (Operation 408). The project attributes may be the same as the program attributes. Alternatively, the project attributes may vary from the program attributes. In some embodiments, the system may determine that further sub-units exist in one or more projects. Sub-units may include sub-projects. The system may iteratively invoke R EST services until the system obtains attribute data for each sub-project.

The system applies a set of rules to identify the top five projects based on the retrieved project metrics (Operation 410). The system may select a set of three metrics, from among over one hundred project metrics, to identify the top five projects. The five project metrics may be metrics that an organization has determined are the most important to the organization. For example, the organization may select five projects as the top five projects based on the following rules:
(a) An ITD cost variance exceeds a threshold (value×weight (0.5));
(b) An ITD labor effort variance exceeds a threshold (value×weight (0.3));
(c) An earned value cost variance exceeds a threshold (value×weight (0.2));
(d) Select up to five projects based on the highest values for the sum of (a), (b), and (c).

The system presents the five projects in the GUI. The projects include “LAF PPM Implementation,” “Fox Stores HCM Implementation,” “Hilman HCM Upgrade,” “Business World ERP Implementation,” and “Fox Stores ERP Upgrade.” The system displays the set of three metrics. The three metrics may be displayed for the overall program. Alternatively, the three metrics may be displayed for the respective projects. The system may display one or more additional metrics, including margin, revenue, at-completion forecast, at-completion budget margin, and budget/actual margin variance.

The system detects the selection of a project “Fox Stores ERP Upgrade” (Operation 412). The selection may include a user interacting with an interface element in a GUI to select the project.

Based on detecting the selection, the system applies a machine learning model to project metric values for the project “Fox Stores ERP Upgrade” to identify key project metrics for the project (Operation 414). The machine learning model predicts the key metrics influencing a project performance classification for the project are ITD margin variance, ITD cost variance, and ITD labor effort variance.

The system generates a prompt to instruct a generative AI model to generate summaries and recommended actions (Operation 416). The system includes the key metrics in the prompt. The generative AI prompt includes instructions to identify the three projects with a combination of the key metrics that have the highest negative variance from average values for the key metrics across the projects in the NA Application Implementations program. The generative AI prompt includes instructions to generate one recommended action to take to improve the key metrics for the three projects to improve the overall performance of the program. The generative AI prompt further includes links to the program data for the projects. The links to the program data include links to tables and records that describe the key metrics for the projects in the program “NA Application Implementation.” The generative AI prompt further includes a reference to a metrics dictionary. The metrics dictionary provides the generative AI model with a description of the metrics that include the program characteristics measured by the metrics.

As an example, the generative AI prompt may include the following:
(a) Assume the role of expert in project management;
(b) Assignment includes North America ERP Rollout program;
(c) Use attached reference data, including program attributes and metrics;
(d) Highlight trends and patterns that inform stakeholders with program's current status and future outlook;
(e) Provide response in [object ID45] compliant JSON object in the following format:
1. project name
2. project summary
3. “Recommendations”:[

<<Provide a prioritized list between 3 to 5, actionable recommendations to address the most critical area of concern. Focus on practical steps that can be implemented immediately to improve project performance. For each recommendation, briefly explain its importance and potential impact. Also, include relevant data points in the recommendation. Each recommendation MUST adhere between 30-50 words. Any additional words will be rejected>>.

The generative AI model identifies the projects “Fox Stores ERP Upgrade,” “Business World ERP Implementation,” and “Hilman HCM Upgrade” as projects that have the highest negative variance for the key metrics compared to average key metric values for the projects in the NA Application Implementations program. The generative AI model generates a recommendation for the Fox Stores ERP Upgrade project to monitor the project's cost performance. The LLM generates a recommendation for the Business World ERP Implementation project to focus on maintaining the project's financial trajectory. The generative AI model generates a recommendation for the Hilman HCM Upgrade project to address marginal financial discrepancies.

The system initiates a recommended action based on detecting a selection of a recommendation (Operation 418). If the system detects a user selecting an interface element associated with the recommendation to “monitor the project's cost performance,” the system generates an alarm or notification in a project monitoring platform configured to alert a user to changes in cost performance for the project. As another example, if the system detects a user selecting an interface element associated with the recommendation to “maintain the project's financial trajectory,” the system may recommend a set of operations associated with maintaining a project's financial trajectory, such as reviewing supplier costs for Supplier A, based on detecting an increase in costs over time. The system may recommend proposing application upgrades to a customer based on the current state of the application being used by the customer and the availability of upgrades for the application.

In one or more embodiments, a system monitors program performance in real-time to modify priorities assigned to programs and projects. For example, two programs associated with rolling out a cloud software service may utilize a set of resources such as servers in a cloud environment. Based on detecting particular values for a set of key project metrics associated with a first program, the system may assign a higher priority to the first program than to a second program. The higher priority may cause a cloud server to process requests associated with the first project prior to processing requests associated with the second project. Accordingly, in real-time, the system implements generative AI-generated recommendations for improving overall program performance by improving the performance of key project metrics.

An example embodiment is described above where a program includes a set of projects associated with sales and costs for a product. In one or more alternative embodiments, a project includes a set of computer code being implemented on a computing device. A program may include a computer program, and projects may include tasks to be performed to execute the computer program. Example metrics may include, for example, a number of tasks, data types, data size of instructions and processing requests, and computer processing capacity required to execute tasks. In this embodiment, the system identifies key program metrics associated with an overall performance of a program, such as execution time of tasks, an estimated time to complete a set of tasks, a processing capacity available to complete tasks, and a number of processors and/or threads required to complete tasks. Based on recommendations generated by a generative AI model, the system may reprioritize tasks by re-assigning processing threads among processing cores in a processor to improve the overall performance of the program.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). A n overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

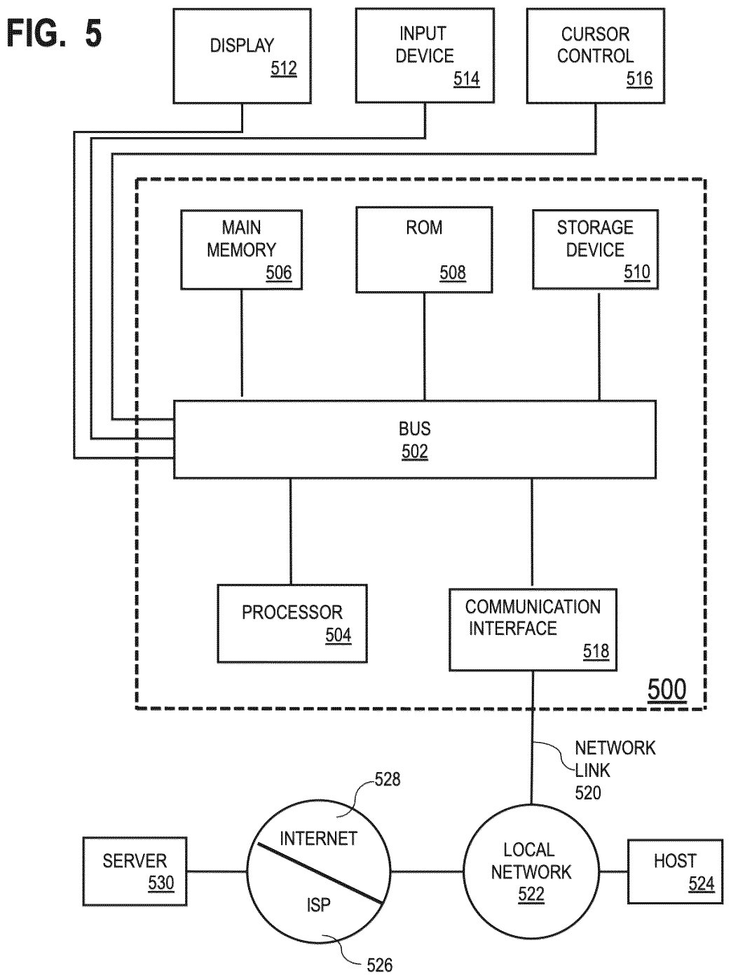

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. N on-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CA M), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LA N) card to provide a data communication connection to a compatible LA N. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media storing instructions that, when executed by one or more hardware processors, cause performance of a set of operations comprising:
invoking a first application programming interface (API) call to a program management platform to access a first set of program attribute data for a program stored by the program management platform, the first set of program attribute data including at least a set of values for a set of program metrics representing a set of performance measures for the program;
selecting a subset of program metrics based on an influence of the subset of attributes on an overall performance of the program;
generating a generative Artificial Intelligence (AI) prompt including instructions to generate at least one recommendation for improving the overall performance of the program based on the subset of metrics determined by the machine learning model; and
initiating a modification to the program based on the at least one recommendation for improving the overall performance of the program.

2. The one or more non-transitory computer readable media of claim 1, wherein initiating the modification comprises:
presenting, in a graphical user interface (GUI) a set of content generated by the generative AI model including (a) a summary of the program, and (b) the at least one recommendation for managing the program.

3. The one or more non-transitory computer readable media of claim 1, wherein selecting the subset of program metrics comprises inputting the set of values for the set of program metrics to a machine learning model to determine the subset of program metrics, and
wherein the machine learning model determines the subset of program metrics based on how a change in values associated with the subset of attributes would influence the overall performance of the program.

4. The one or more non-transitory computer readable media of claim 1, further comprising:
detecting an action recommendation trigger associated with the overall performance of the program,
wherein inputting the set of values for the set of program metrics to the machine learning model is performed based at least on detecting the action recommendation trigger.

5. The one or more non-transitory computer readable media of claim 1, wherein generating a generative AI prompt comprises:
providing the first subset of program attributes to a software module comprising software code for generating the generative AI prompt based on at least one of (a) the program attribute data and (b) user attributes of at least one user associated with the action recommendation trigger; and
using the software code to generate the generative AI prompt.

6. The one or more non-transitory computer readable media of claim 1, wherein the operations further comprise:
determining the program comprises at least a first project and a second project; and
based on determining the program comprises at least the first project and the second project: initiating a second API call to access first project attributes for the first project; and
initiating a second API call to access second project attributes for the second project.

7. The one or more non-transitory computer readable media of claim 1, wherein selecting the subset of program metrics comprises inputting the set of values for the set of program metrics to a machine learning model to determine the subset of program metrics, and
wherein the machine learning model predicts the subset of program attributes having the greatest influence on the overall performance of the program at least by predicting a ranking value for each of the program attributes, wherein the subset of program attributes has the highest ranking values among the program attributes.

8. The one or more non-transitory computer readable media of claim 7, wherein the operations further comprise:
determining a first ranking value of a first program attribute among the subset of program attributes fails to meet a threshold ranking value; and
based on determining the first ranking value fails to meet the threshold ranking value: determining a second subset of program attributes associated with the program; and
replacing the first program attribute with a second program attribute from among the second subset of program attributes.

9. The one or more non-transitory computer readable media of claim 1, wherein generating the generative AI prompt comprises:
including in the generative AI prompt a first set of metadata including descriptions of the program metrics.

10. The one or more non-transitory computer readable media of claim 1, wherein generating the generative AI prompt comprises:
including in the generative AI prompt a pointer to a storage location for at least the subset of program metrics.

11. The one or more non-transitory computer readable media of claim 1, wherein initiating the modification comprises: prioritizing processing of a particular project of the program by a central processing unit (CPU), wherein a program metric corresponding to the particular project is determined to have an influence on the overall performance of the program that meets one or more threshold criteria.

12. A method comprising:
invoking a first application programming interface (API) call to a program management platform to access a first set of program attribute data for a program stored by the program management platform, the first set of program attribute data including at least a set of values for a set of program metrics representing a set of performance measures for the program;
selecting a subset of program metrics based on an influence of the subset of attributes on an overall performance of the program;
generating a generative Artificial Intelligence (AI) prompt including instructions to generate at least one recommendation for improving the overall performance of the program based on the subset of metrics determined by the machine learning model; and
initiating a modification to the program based on the at least one recommendation for improving the overall performance of the program.

13. The method of claim 12, wherein initiating the modification comprises:
presenting, in a graphical user interface (GUI) a set of content generated by the generative AI model including (a) a summary of the program, and (b) the at least one recommendation for managing the program.

14. The method of claim 12, wherein selecting the subset of program metrics comprises inputting the set of values for the set of program metrics to a machine learning model to determine the subset of program metrics, and
wherein the machine learning model determines the subset of program metrics based on how a change in values associated with the subset of attributes would influence the overall performance of the program.

15. The method of claim 12, further comprising:
detecting an action recommendation trigger associated with the overall performance of the program,
wherein inputting the set of values for the set of program metrics to the machine learning model is performed based at least on detecting the action recommendation trigger.

16. The method of claim 15, wherein generating a generative AI prompt comprises:
providing the subset of program metrics to a software module comprising software code for generating the generative AI prompt based on at least one of (a) the first set of program attribute data and (b) user attributes of at least one user associated with the action recommendation trigger; and
using the software code to generate the generative AI prompt.

17. The method of claim 12, further comprising:
determining the program comprises at least a first project and a second project; and
based on determining the program comprises at least the first project and the second project: initiating a second API call to access first project attributes for the first project; and
initiating a second API call to access second project attributes for the second project.

18. The method of claim 12, wherein selecting the subset of program metrics comprises inputting the set of values for the set of program metrics to a machine learning model to determine the subset of program metrics, and
wherein the machine learning model predicts the subset of program attributes having the greatest influence on the overall performance of the program at least by predicting a ranking value for each of the program attributes, wherein the subset of program attributes has the highest ranking values among the program attributes.

19. The method of claim 18, further comprising:
determining a first ranking value of a first program attribute among the subset of program attributes fails to meet a threshold ranking value; and
based on determining the first ranking value fails to meet the threshold ranking value: determining a second subset of program attributes associated with the program; and
replacing the first program attribute with a second program attribute from among the second subset of program attributes.

20. A system comprising at least one device including one or more hardware processors, the system being configured to execute instructions with the one or more hardware processors to perform a set of operations comprising:
invoking a first application programming interface (API) call to a program management platform to access a first set of program attribute data for a program stored by the program management platform, the first set of program attribute data including at least a set of values for a set of program metrics representing a set of performance measures for the program;
selecting a subset of program metrics based on an influence of the subset of attributes on an overall performance of the program;
generating a generative Artificial Intelligence (AI) prompt including instructions to generate at least one recommendation for improving the overall performance of the program based on the subset of metrics determined by the machine learning model; and
initiating a modification to the program based on the at least one recommendation for improving the overall performance of the program.
